(19) United States
(12) Patent Application Publication
(10) Pub. No.: US 2026/0337020 A1
(43) Pub. Date: Oct. 29, 2026

(54) METHOD FOR IMPROVING START-UP STABILITY OF STEAM METHANE REFORMER AND OPTIMIZING AMOUNT OF CIRCULATING GAS USED AND APPARATUS THEREFOR

(71) Applicants: Hyundai Motor Company, Seoul (KR); Kia Corporation, Seoul (KR)

(72) Inventor: Dong Seok KO, Hwaseong-Si (KR)

(73) Assignees: Hyundai Motor Company, Seoul (KR); Kia Corporation, Seoul (KR)

(21) Appl. No.: 19/309,225

(22) Filed: Aug. 25, 2025

(30) Foreign Application Priority Data
Apr. 29, 2025 (KR) 10-2025-0056537

(51) Int. Cl. C01B 3/34; B01J 19/00

(52) U.S. Cl. CPC C01B 3/34; B01J 19/0013; B01J 2219/00162; B01J 2219/0027; C01B 2203/0205; C01B 2203/1241; C01B 2203/1604; C01B 2203/1633; C01B 2203/1638

(57) ABSTRACT

A method for improving the start-up stability of a steam methane reformer and optimizing the amount of circulating gas used and an apparatus therefor, includes supplying gas for start-up by opening a supply valve for the gas for start-up, based on start-up of the steam methane reformer, activating an operation mode of a pressure indicating controller as an auto mode, and controlling, by the pressure indicating controller, a pressure control valve to match a supply flow rate of the gas for start-up and a flow rate of gas emitted to the outside based on that internal pressure reaches a target value as the gas for start-up is supplied.

### CROSS-REFERENCE TO RELATED APPLICATION

The present application claims the benefit of priority to Korean Patent Application No. 10-2025-0056537, filed in the Korean Intellectual Property Office on Apr. 29, 2025, the entire contents of which are incorporated herein by reference.

### TECHNICAL FIELD

The present disclosure relates to a steam methane reformer, and more particularly, relates to technologies for improving the start-up stability of the steam methane reformer and optimizing the amount of circulating gas used.

### BACKGROUND

Facilities which continuously should supply hydrogen may sometimes produce hydrogen by reforming steam methane. Variability in energy consumption and temperature/pressure in such equipment has an influence on cost, production quality, and safety.

Natural gas reforming has been developed into an advanced and mature process based on existing natural gas availability and an existing natural gas infrastructure. 95% of hydrogen produced in the United States is produced using the natural gas reforming.

A steam methane reformer (SMR) is equipment for reforming methane which is a main component of natural gas using steam to produce hydrogen and emitting carbon. At the instant time, the produced hydrogen is gray hydrogen. If capturing/storing/using carbon emitted when hydrogen is manufactured, the gray hydrogen becomes blue hydrogen.

To increase the efficiency of the steam methane reformer, it is important to minimize consumption of gas used upon start-up and stabilize system's internal pressure as a certain level upon initial start-up.

However, because an existing technology provides only a function of turning on or off a valve for supplying gas for start-up, it is unable to efficiently control the amount of gas for start-up, which is used.

### SUMMARY

The present disclosure has been made to solve the above-mentioned problems occurring in the related art while advantages achieved by the related art are maintained intact.

Various aspects of the present disclosure provide a method for improving the start-up stability of a steam methane reformer and optimizing the amount of circulating gas used and an apparatus therefor.

Various aspects of the present disclosure provide a steam methane reformer for adaptively controlling a flow rate of gas for start-up depending on system's internal pressure to improve start-up stability and optimize the amount of circulating gas used.

Various aspects of the present disclosure provide a method for improving the start-up stability of a steam methane reformer and optimizing the amount of circulating gas used to interlock a pressure indicating controller and a flow indicating controller to adaptively control a mode of the flow indicating controller to minimize a pressure instability interval and minimize the amount of start-up gas emitted to the outside and an apparatus therefor.

The technical problems to be solved by the present disclosure are not limited to the aforementioned problems, and any other technical problems not mentioned herein will be clearly understood from the following description by those skilled in the art to which the present disclosure pertains.

According to various aspects of the present disclosure, a method of a steam methane reformer may include supplying gas for start-up by opening a supply valve for the gas for start-up, based on start-up of the steam methane reformer, activating an operation mode of a pressure indicating controller as an auto mode, and controlling, by the pressure indicating controller, a pressure control valve to match a supply flow rate of the gas for start-up and a flow rate of gas emitted to the outside based on that internal pressure reaches a target value as the gas for start-up is supplied.

According to various aspects of the present disclosure, the method may further include switching the operation mode of a flow indicating controller from the auto mode to a cascade mode based on that the internal pressure reaches the target value and turning on a flow indicating controller set point (SP) calculator for determining an SP of the flow indicating controller based on an output (OP) of the pressure indicating controller.

According to various aspects of the present disclosure, the flow indicating controller for adjusting an open degree of a flow control valve and the pressure indicating controller for adjusting an open degree of the pressure control valve may interlock with each other based on switching to the cascade mode. The flow indicating controller SP calculator may set the SP so that the pressure indicating controller stably maintains the internal pressure.

According to various aspects of the present disclosure, the method may further include reducing the supply flow rate of the gas for start-up while maintaining the internal pressure as the target value via the interlocking in the cascade mode.

According to various aspects of the present disclosure, the supply flow rate of the gas for start-up may decrease to a set lower limit value of the flow indicating controller. The lower limit value may be a value at a time point when the open degree of the pressure control valve is 50% in the cascade mode.

According to various aspects of the present disclosure, the supply flow rate of the gas for start-up in the cascade mode may decrease to a flow rate of a minimum level for stably maintaining the internal pressure and may ideally decrease to a level of 20% of the supply flow rate of the gas for start-up in the auto mode depending on specifications of a system.

According to various aspects of the present disclosure, a steam methane reformer may include a supply valve for gas for start-up which is opened based on start-up to supply the gas for start-up to the inside of the steam methane reformer, a pressure indicating controller which is configured for monitoring a change in an internal pressure as the gas for start-up is supplied and control the internal pressure, and a pressure control valve that adjusts an open degree depending on an output (OP) of the pressure indicating controller and emit the gas for start-up to the outside thereof. The pressure indicating controller may be configured for controlling the pressure control valve so that a supply flow rate of the gas for start-up and a flow rate of the emitted gas are identical to each other based on that internal pressure reaches a predetermined target value.

According to various aspects of the present disclosure, an operation mode of the pressure indicating controller may be activated as an auto mode upon the start-up.

According to various aspects of the present disclosure, the steam methane reformer may further include a flow control valve that adjusts the supply flow rate of the gas for start-up, a flow indicating controller that controls an open degree of the flow control valve, and a flow indicating controller set point (SP) calculator that determines an SP of the flow indicating controller based on the OP of the pressure indicating controller. The operation mode of the flow indicating controller may switch from the auto mode to a cascade mode to turn on the flow indicating controller SP calculator, based on that the internal pressure reaches the target value.

According to various aspects of the present disclosure, the flow indicating controller and the pressure indicating controller may interlock with each other based on switching to the cascade mode. The flow indicating controller SP calculator may set the SP so that the pressure indicating controller stably maintains the internal pressure.

According to various aspects of the present disclosure, the pressure indicating controller may be configured for controlling the flow indicating controller to decrease the supply flow rate of the gas for start-up while maintaining the internal pressure as the target value via the interlocking in the cascade mode.

According to various aspects of the present disclosure, the supply flow rate of the gas for start-up may decrease to a set lower limit value of the flow indicating controller. The lower limit value may be a value at a time point when the open degree of the pressure control valve is 50% in the cascade mode.

According to various aspects of the present disclosure, the supply flow rate of the gas for start-up in the cascade mode may decrease to a flow rate of a minimum level for stably maintaining the internal pressure and may ideally decrease to a level of 20% of the supply flow rate of the gas for start-up in the auto mode depending on specifications of a system.

According to various aspects of the present disclosure, an interval in which the internal pressure is unstable may occur in an interval in which the supply flow rate of the gas for start-up is greater than the flow rate of the gas emitted to the outside after the internal pressure reaches the target value. The supply flow rate of the gas for start-up may decrease to a certain level to minimize the unstable interval based on that the internal pressure reaches the target value.

According to various aspects of the present disclosure, the target value may be set to a value of any one of greater than 0 barg or less than 10 barg and may be ideally set to a value of any one of greater than 7 barg or less than 8 barg depending on the specifications of the system.

According to various aspects of the present disclosure, the gas for start-up may include at least one or more of hydrogen gas or nitrogen gas.

### BRIEF DESCRIPTION OF THE DRAWINGS

The above and other objects, features and advantages of the present disclosure will be more apparent from the following detailed description taken in conjunction with the accompanying drawings:

FIG. 1 is a drawing for describing a configuration and an operation principle of a steam methane reformer according to an exemplary embodiment of the present disclosure;

FIG. 2 is a flowchart for describing a flow rate and pressure control method in a steam methane reformer of FIG. 1;

FIG. 3 is a drawing for describing a flow rate and pressure control mechanism in a steam methane reformer according to an exemplary embodiment of the present disclosure;

FIG. 4 is a drawing for describing a configuration and an operation principle of a steam methane reformer according to another embodiment of the present disclosure;

FIG. 5 is a drawing for describing a method for controlling a mode of a flow indicating controller in a steam methane reformer according to an exemplary embodiment of the present disclosure of FIG. 4;

FIG. 6A is a flowchart for describing a method in a steam methane reformer according to an exemplary embodiment of the present disclosure of FIG. 4;

FIG. 6B is a flowchart for describing SP value determination logic of a flow indicating controller SP calculator in a cascade mode according to an exemplary embodiment of the present disclosure;

FIG. 7 is a drawing for describing a flow rate and pressure control mechanism via controller interlocking of a steam methane reformer and an effect according to it according to an exemplary embodiment of the present disclosure of FIG. 4; and

FIG. 8 illustrates a computing system according to an exemplary embodiment of the present disclosure.

### DETAILED DESCRIPTION

Hereinafter, various exemplary embodiments of the present disclosure will be described in detail with reference to the exemplary drawings. In adding the reference numerals to the components of each drawing, it should be noted that the identical component is designated by the identical numerals even when they are displayed on other drawings. Furthermore, in describing the exemplary embodiment of the present disclosure, a detailed description of well-known features or functions will be ruled out in order not to unnecessarily obscure the gist of the present disclosure.

In describing the components of the exemplary embodiment according to an exemplary embodiment of the present disclosure, terms such as first, second, “A”, “B”, (a), (b), and the like may be used. These terms are merely intended to distinguish one component from another component, and the terms do not limit the nature, sequence or order of the corresponding components. Furthermore, unless otherwise defined, all terms including technical and scientific terms used herein have the same meaning as being generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

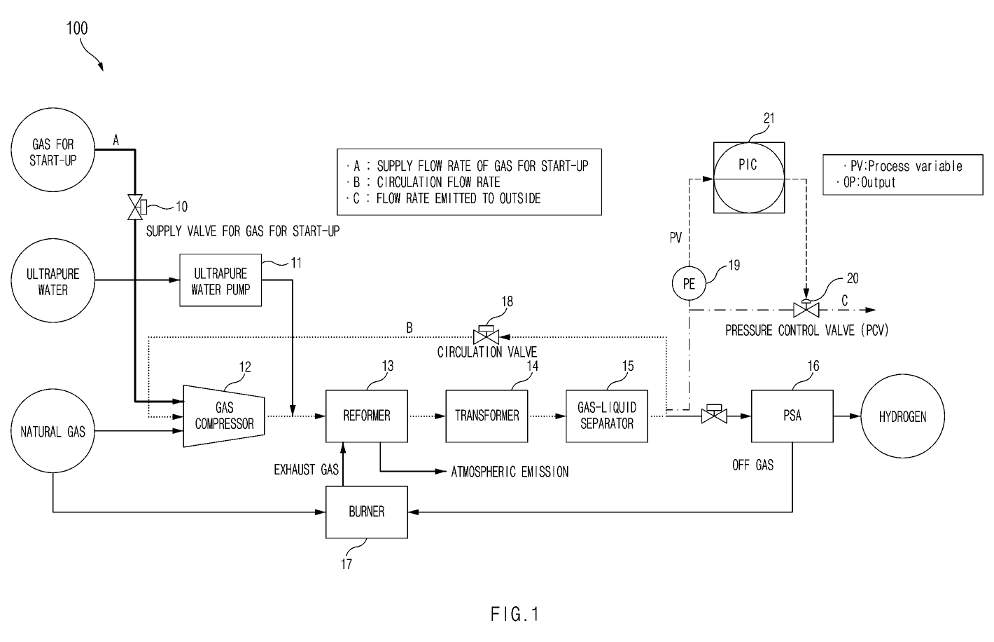

Hereinafter, embodiments of the present disclosure will be described in detail with reference to FIGS. 1-8.

FIG. 1 is a drawing for describing a configuration and an operation principle of a steam methane reformer according to an exemplary embodiment of the present disclosure.

Referring to FIG. 1, a steam methane reformer (SMR) 100 may include a supply valve 10 for gas for start-up, an ultrapure water pump 11, a gas compressor 12, a reformer 13, a transformer 14, a gas-liquid separator 15, pressure swing adsorption (PSA) 16, a burner 17, a circulation valve 18, a pressure element (PE) 19, a pressure control valve (PCV) 20, and a pressure indicating controller (PIC) 21.

The entire reaction formula of a stream methane reforming method which is a process of reforming natural gas which is mostly composed of methane to produce hydrogen is as follows.
CH4 + 2H2O -> CO2 + 4H2

The SMR 100 may reach normal operation via an initial start-up procedure.

In the start-up process, the SMR 100 may perform a series of procedures, such as supply of gas for start-up -> internal recirculation -> heating -> rising pressure -> feed -> PSA operation, and may switch to a normal operation state, when internal pressure reaches a target value via the procedure.

The start-up process may be a process in which pressure in the system fluctuates from a stop state of 0 barg to normal operation pressure of about 7~8 barg and may be important to stably maintain pressure in the system.

Furthermore, the start-up process may be a process in which the pressure in the system fluctuates from the stop state of 0 barg to any one value of less than 10 barg. In the instant case, it may be important to stably maintain pressure in the system.

Gas for start-up and feed may continuously circulate before normal operation and some gases may be emitted to the outside to maintain an internal pressure if necessary. In the present process, the supply valve 10 for gas for start-up may be opened and operated at a certain open degree. The remaining gas for start-up except for the amount necessary to maintain pressure may be continuously emitted to the outside via the PCV 20.

Hereinafter, a description will be given in detail of a process of producing hydrogen using the components of the SMR 100.

The supply valve 10 for gas for start-up may be a control valve for supplying gas used upon start-up of the SMR 100. Gas for start-up may include nitrogen (N₂), hydrogen (H₂), and the like.

The ultrapure water pump 11 may minimize organic matter, electrical conductivity, or the like and may pressure and output ultrapure water which is water with almost no impurities to a certain level. As an example, the ultrapure water pump 11 may pressure and output ultrapure water to about 8 barg.

The gas compressor 12 may pressure and output natural gas, which is supply fuel of the SMR 100, to the certain level. As an example, the gas compressor 12 may pressure and output natural gas to about 8 barg.

The pressured natural gas and the pressured ultrapure water may be supplied to the reformer 13.

The reformer 13 may allow the natural gas and the ultrapure water to reach with each other at high pressure/high temperature to produce hydrogen. In other words, the reformer 13 may produce carbon dioxide and hydrogen via an endothermic reaction between the natural gas and the ultrapure water depending on the reaction formula, CH₄ + 2H₂O -> CO₂ + 4H.

The transformer 14 may produce and output hydrogen (H₂) and carbon dioxide (CO₂) via an exothermic reaction between carbon monoxide (CO) of the hydrogen produced by the reformer 13 and ultrapure water (H₂0) depending on the reaction formula, CO + H₂O → CO₂ + H₂.

The gas-liquid separator 15 may remove moisture included in the output of the transformer 14.

The PSA 16 may be a device which separates and refines only hydrogen from the mixture gas produced by the reformer 13 and the transformer 14. At the instant time, a separation gas except for hydrogen is called an off gas.

The burner 17 may burn the natural gas and the off gas to supply heat necessary for the endothermic reaction of the reformer 13.

The circulation valve 18 may be a valve for controlling circulation of flow rate B among the gas compressor 12, the reformer 13, the transformer 14, and the gas-liquid separator 15, upon the start-up of the SMR 100. A pipe line may be formed so that the output of the gas-liquid separator 15 is circulated and supplied to the gas compressor 12.

The PCV 20 may be a valve for controlling internal pressure upon the start-up of the SMR 100, which may be disposed for adjusting flow rate C depending on a control signal of the PIC 21. To the present end, a pipe line may be disposed between the output of the gas-liquid separator 15 and the PCV 20. Herein, the PE 19 is for measuring pressure of a flow rate flowing in the pipe between the gas-liquid separator 15 and the PCV 20. The PE 19 may transmit a process variable (PV) value which is pressure detecting information to the PIC 21. The PIC 21 may output an output (OP) which is a command for adjusting the PCV 20 based on the PV value. The PIC 21 may adjust an open degree of the PCV 20 until the internal pressure reaches a certain target value.

When the internal pressure reaches the target value, the PIC 21 may adjust the open degree of the PCV 20 so that flow rate A supplied for start-up and flow rate C which is a start-up gas emitted to the outside are kept the same. When the amount of gas A supplied for start-up is greater than the amount of gas C emitted to the outside thereof, a pressure instability interval may occur. The PIC 21 may keep the amount of start-up gas supply A and the amount of external emission C the same so that the internal pressure is able to be stabilized at the target value.

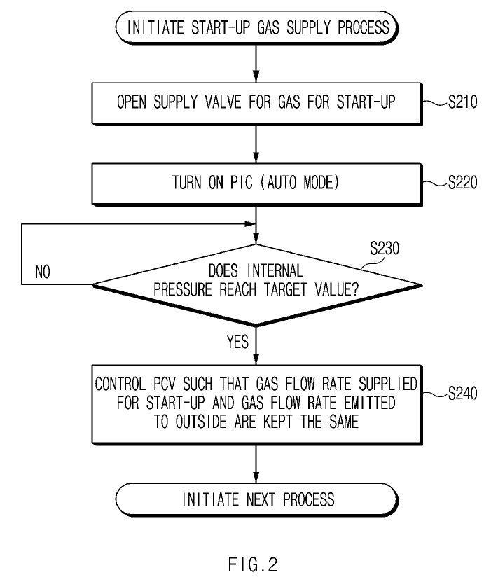

FIG. 2 is a flowchart for describing a flow rate and pressure control method in a steam methane reformer (SMR) of FIG. 1.

Referring to FIGS. 1 and 2, when a start-up gas supply process is initiated, in S210, an SMR 100 may open a supply valve 10 for gas for start-up.

In S220, the SMR 100 may turn on a PIC 21 in an auto mode to perform internal pressure monitoring.

In S230, the SMR 100 may compare the measured internal pressure with a predetermined target value to determine whether the internal pressure reaches the target value.

When the internal pressure reaches the target value as a result of the determination, in S240, the SMR 100 may be configured for controlling a PCV 20 so that gas flow rate A supplied for start-up and gas flow rate C emitted to the outside are kept the same.

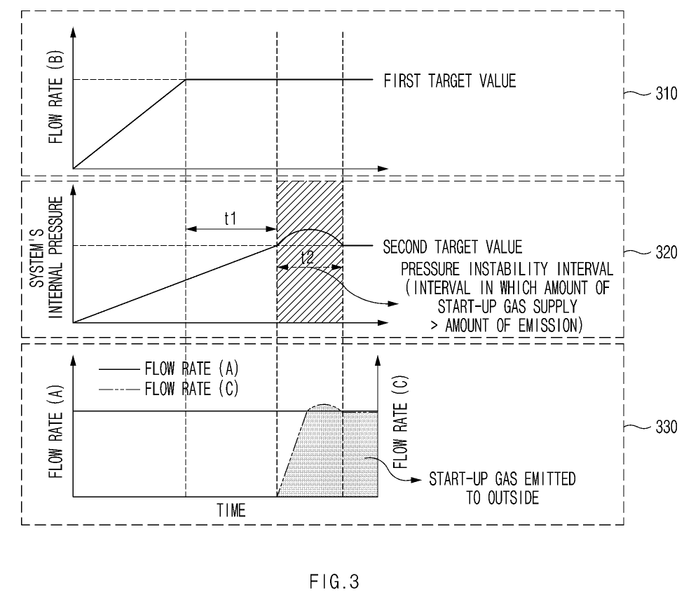

FIG. 3 is a drawing for describing a flow rate and pressure control mechanism in a steam methane reformer (SMR) 100 according to an exemplary embodiment of the present disclosure.

Referring to reference numeral 310 of FIG. 3, when gas A for start-up is supplied, circulation flow rate B may increase and system’s internal pressure may simultaneously increase.

Referring to reference numerals 310 and 320, it may take an additional time t1 until the system’s internal pressure reaches a predetermined second target value, although circulation flow rate B reaches a predetermined first target value, and the internal pressure may be unstable in an interval t2 in which the amount of start-up gas supply is greater than the amount of external emission, although the system’s internal pressure reaches the second target value.

As shown in reference numeral 330, the SMR 100 according to an exemplary embodiment of the present disclosure may be configured for controlling to keep a balance between flow rate A of gas for start-up, which is supplied by adjusting an open degree of the PCV 20, and external emission flow rate C to stabilize the system’s internal pressure as the second target value.

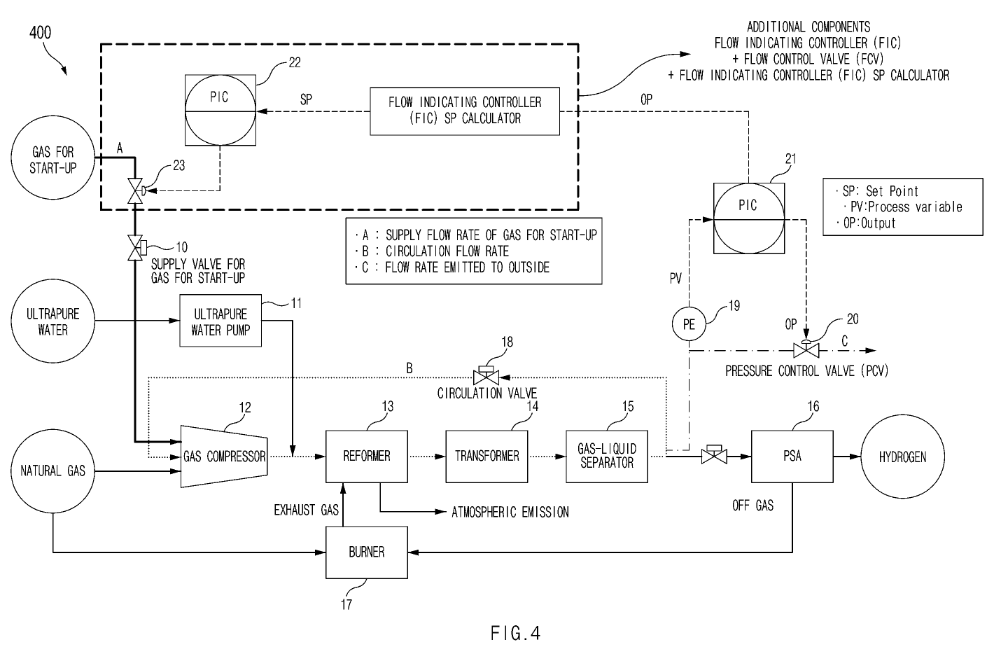

FIG. 4 is a drawing for describing a configuration and an operation principle of a steam methane reformer (SMR) according to another embodiment of the present disclosure.

Referring to FIG. 4, an SMR 400 may include a supply valve 10 for gas for start-up, an ultrapure water pump 11, a gas compressor 12, a reformer 13, a transformer 14, a gas-liquid separator 15, pressure swing adsorption (PSA) 16, a burner 17, a circulation valve 18, a pressure element (PE) 19, a pressure control valve (PCV) 20, a pressure indicating controller (PIC) 21, a flow indicating controller (FIC) 22, a flow control valve (FCV) 23, and a FIC SP calculator 24.

An operation mode of the SMR 400 according to an exemplary embodiment of the present disclosure may operate as any one of a manual mode, an auto mode, or a cascade mode. The SMR 400 according to an exemplary embodiment of the present disclosure may set a default operation mode to the cascade mode.

For the manual mode or the auto mode, the FIC 22 may operate as an independent controller to control a flow rate of gas for start-up. For the manual mode, the FIC 22 may interlock with the PIC 21 and may determine an SP value of the FIC 22 by the FIC SP calculator 24 depending on the OP value of the PIC 21 to control a flow rate of gas for start-up. The FIC 22 according to an exemplary embodiment of the present disclosure may dynamically interlock with the PIC 21 depending on a real-time change in an internal pressure, thus more organically controlling a flow rate of gas for start-up.

The entire reaction formula of a stream methane reforming method which is a process of reforming natural gas which is mostly composed of methane and producing hydrogen is as follows.
CH4 + 2H2O -> CO2 + 4H2

The SMR 400 may reach normal operation via an initial start-up procedure.

In the start-up process, the SMR 400 may perform a series of procedures, such as supply of gas for start-up -> internal recirculation -> heating -> rising pressure -> feed -> PSA operation, and may rapidly stabilize internal pressure via mode switching to switch to a normal operation state, when the internal pressure reaches a target value via the procedure. Herein, the mode switching refers to switching from the auto mode to the cascade mode.

The start-up process may be a process in which pressure in the system fluctuates from a stop state of 0 barg to normal operation pressure of about 7~8 barg and may be important to stably maintain pressure in the system.

Gas for start-up and feed may continuously circulate before normal operation and some gases may be emitted to the outside to maintain an internal pressure if necessary. In the present process, the supply valve 10 for gas for start-up may be opened and operated at a certain open degree. The remaining gas for start-up except for the amount necessary to maintain pressure may be continuously emitted to the outside via the PCV 20.

Hereinafter, a description will be given in detail of a process of producing hydrogen using the components of the SMR 400.

The supply valve 10 for gas for start-up may be a control valve for supplying gas used upon start-up of the SMR 400. Gas for start-up may include nitrogen (N₂) and hydrogen (H₂).

The ultrapure water pump 11 may minimize organic matter, electrical conductivity, or the like and may pressure and output ultrapure water which is water with almost no impurities to a certain level. As an example, the ultrapure water pump 11 may pressure and output ultrapure water to about 8 barg.

The gas compressor 12 may pressure and output natural gas, which is supply fuel of the SMR 400, to the certain level. As an example, the gas compressor 12 may pressure and output natural gas to about 8 barg.

The pressured natural gas and the pressured ultrapure water may be supplied to the reformer 13.

The reformer 13 may allow the natural gas and the ultrapure water to reach with each other at high pressure/high temperature to produce hydrogen. In other words, the reformer 13 may produce carbon dioxide and hydrogen via an endothermic reaction between the natural gas and the ultrapure water depending on the reaction formula, CH₄ + 2H₂O -> CO₂ + 4H.

The transformer 14 may produce and output hydrogen (H₂) and carbon dioxide (CO₂) via an exothermic reaction between carbon monoxide (CO) of the hydrogen produced by the reformer 13 and ultrapure water (H₂0) depending on the reaction formula, CO + H₂O → CO₂ + H₂.

The gas-liquid separator 15 may remove moisture included in the output of the transformer 14.

The PSA 16 may be a device which separates and refines only hydrogen from the mixture gas produced by the reformer 13 and the transformer 14. At the instant time, a separation gas except for hydrogen is called an off gas.

The burner 17 may burn the natural gas and the off gas to supply heat necessary for the endothermic reaction of the reformer 13.

The circulation valve 18 may be a valve for controlling circulation of flow rate B among the gas compressor 12, the reformer 13, the transformer 14, and the gas-liquid separator 15, upon the start-up of the SMR 400. A pipe line may be formed so that the output of the gas-liquid separator 15 is circulated and supplied to the gas compressor 12.

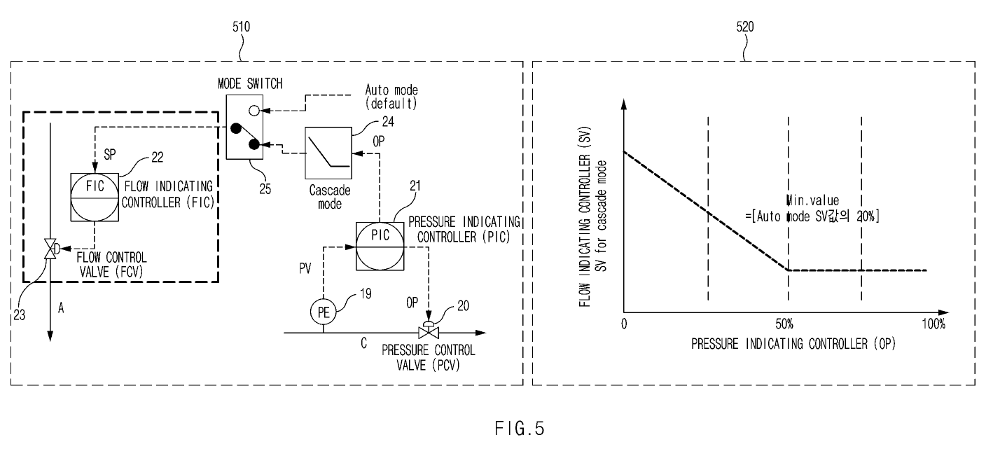

The PCV 20 may be a valve for controlling internal pressure upon the start-up of the SMR 400, which may be for adjusting flow rate C depending on a control signal of the PIC 21. To the present end, a pipe line may be disposed between the output of the gas-liquid separator 15 and the PCV 20. Herein, the PE 19 is for measuring pressure of a flow rate flowing in the pipe between the gas-liquid separator 15 and the PCV 20. The PE 19 may transmit a process variable (PV) value which is pressure detecting information to the PIC 21. The PIC 21 may output an output (OP) which is a command for adjusting the PCV 20 based on the PV value. In a manual or auto mode, the PIC 21 may switch to a cascade mode to interlock with the FIC 22, when internal pressure reaches a certain target value. The SMR 400 according to an exemplary embodiment of the present disclosure may include a mode switch 25 shown in reference numeral 510 of FIG. 5, which will be described below, for switching an operation mode.

As an exemplary embodiment of the present disclosure, the operation mode may include the manual mode, the auto mode, and a cascade mode. A default operation mode may be set to any one of the manual mode, the auto mode, or the cascade mode depending on a design of those skilled in the art.

When the internal pressure reaches the target value, the PIC 21 may be configured for controlling so that supply of gas for start-up decreases to a certain minimum value while the internal pressure is stably maintained as the target value so that flow rate A supplied for start-up and flow rate C which is a start-up gas emitted to the outside are reduced at the same time.

As the gas supply for start-up is reduced, the PIC 21 may adjust an open degree of the PCV 20 to reduce a gas flow rate emitted to the outside thereof.

As an example, while controlling a flow rate of gas for start-up in the manual mode or the auto mode before entering the cascade mode, when the internal pressure reaches the target value, the SMR 400 may switch the FIC 22 to the cascade mode. The FIC set point (SP) calculator 24 may determine and provide an SP value of the FIC 22 to the FIC 22 depending on an output (OP) value of the PIC 21 in the cascade mode. In other words, the FIC 22 may operate as an independent controller or a slave controller dependent on the PIC 21 which is a master controller, in accordance with the operation mode.

As described above, the SMR 400 according to the exemplary embodiment of the present disclosure may adaptively interlock the PIC 21 and the FIC 22 depending on a change in an internal pressure upon initial start-up, thus minimizing consumption of gas for start-up and more rapidly stabilizing internal pressure for normal operation.

FIG. 5 is a drawing for describing a method for controlling a mode of a flow indicating controller (FIC) in a steam methane reformer (SMR) according to an exemplary embodiment of the present disclosure of FIG. 4.

Referring to reference numeral 510 of FIG. 5, when internal pressure reaches a certain target value, a FIC 22 may switch from an auto mode (or a manual mode) to a cascade mode.

When an operation mode switches from the auto mode (or the manual mode) to the cascade mode to prevent an open degree of a PCV 20 from being sharply changed, an SP value of the FIC 22 may be changed by a FIC SP calculator 24 as follows.

In general, the PCV 20 operates at an open degree of 20~80% and maintains an open degree of about 50% upon normal operation.

Thus, preferably, when an OP value of a PIC 21, that is, an opening ratio of the PCV 20 becomes 50%, it may be set to a lower limit control value of the FIC 22. As an example, in the cascade mode, an SP lower limit value of the FIC 22 may be controlled to be 20% of an SP value in the normal operation (or the auto mode), as shown in reference numeral 520. As an exemplary embodiment of the present disclosure, in the cascade mode, the SP lower limit value of the FIC 22 may be controlled to be a flow rate of a minimum level for stably maintaining internal pressure.

The reason why the OP of the PIC 21 = 50% is criteria is as follows.

When the OP value of the PIC 21 reaches the SP lower limit value of the FIC 22 at 25%, the PCV 20 may rapidly stabilize internal pressure, but may operate at an open degree of 25%. This is not a preferable operation method in terms of an open degree of a control valve.

The reason why the SP lower limit value of the FIC 22 is set to 20% is to reflect a lower limit value of a general control range of 20~80%.

For a control valve using a pneumatic actuator which operates using air, it is common to show a change in open degree of 2~5% per second. On the other hand, for a control valve using an electric actuator, it is common to show a change in open degree of 5~10% per second.

Thus, it may take about 10~25 seconds for an open degree to reach 50% after the PCV 20 is opened.

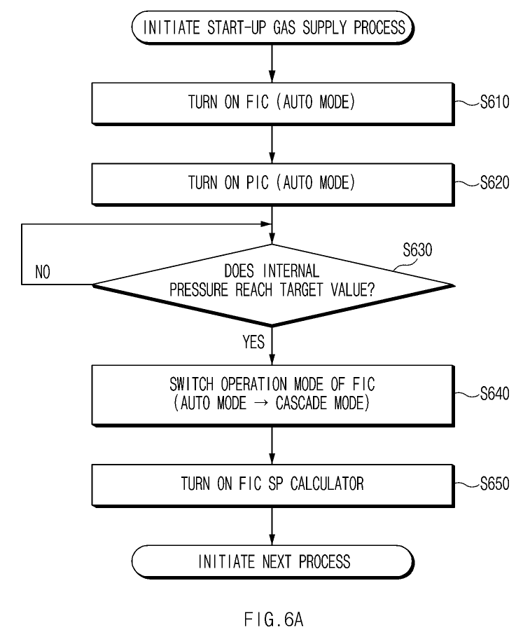

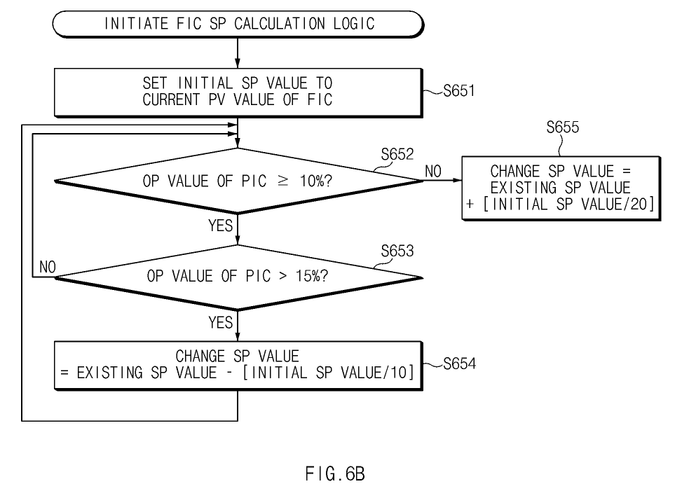

FIG. 6A is a flowchart for describing a method in a steam methane reformer (SMR) according to an exemplary embodiment of the present disclosure of FIG. 4.

Referring to FIGS. 4 and 6A, when a start-up gas supply process is initiated, in S610 and S620, an SMR 400 may turn on a FIC 22 and a PIC 21 in a default mode and may monitor system's internal pressure. Herein, the default mode may be an auto mode (or a manual mode).

In S630, the SMR 400 may compare the measured internal pressure with a predetermined target value to determine whether the internal pressure reaches the target value.

When the internal pressure reaches the target value as a result of the determination, in S640, the SMR 400 may switch an operation mode of the FIC 22 from the default mode to a cascade mode.

In S650, the SMR 400 which enters the cascade mode may turn on a FIC SP calculator 24.

In the cascade mode, the SMR 400 may decrease supply of gas for start-up and gas emitted to the outside to a certain level, while maintaining the internal pressure as the target value.

As described above, the method of the SMR 400 according to the exemplary embodiment of the present disclosure may switch the operation mode from the auto mode which is the default mode to the cascade mode based on that the internal pressure reaches the target value upon initial start-up, thus minimizing consumption of gas for start-up and more rapidly stabilizing internal pressure for normal operation via interlocking between the PIC 21 and the FIC 22 according to it.

FIG. 6B is a flowchart for describing SP value determination logic of a flow indicating controller SP calculator in a cascade mode according to an exemplary embodiment of the present disclosure.

Referring to FIG. 6B, when a FIC SP calculator 24 is turned on in S650 of FIG. 6A, in S651, it may set an initial SP value to a current PV value of a FIC 22.

In S652, the FIC SP calculator 24 may check whether an OP value of a PIC 21 is greater than or equal to 10%.

When the OP value of the PIC 21 is greater than or equal to 10% as a result of the checking, in S653, the FIC SP calculator 24 may check whether the OP value of the PIC 21 is greater than 15%.

When the OP value of the PIC 21 is greater than 15% as a result of the checking, in S654, the FIC SP calculator 24 may change an SP value to a value obtained by subtracting a value obtained by dividing the initial SP value by 10 from an existing SP value. Thereafter, the FIC SP calculator 24 may return to S652.

When the OP value of the PIC 21 is less than or equal to 15% in S653, the FIC SP calculator 24 may return to S652.

When the OP value of the PIC 21 is less than 10% as a result of the checking in S652, in S655, the FIC SP calculator 24 may change the SP value to a value obtained by adding a value obtained by dividing the initial SP value by 20 to the existing SP value. Thereafter, the FIC SP calculator 24 may return to S652.

As shown in FIG. 6B, according to SP determination logic of the FIC SP calculator 24, the FIC SP calculator 24 may set the SP value of the FIC 22 so that the OP value of the PIC 21 is able to be maintained as 10% to 15%. Furthermore, the FIC SP calculator 24 may set the SP value of the FIC 22 so that the PIC 21 stably maintains internal pressure. Herein, the reason why a flow rate of gas for start-up is not controlled to 0 is to prevent a phenomenon in which system's internal pressure converges less than target pressure because a delay occurs until the PCV 20 is closed.

In the embodiment, the reason why the OP value of the PIC 21 is maintained as 10-15% is because control is smoothly performed in an interval of 10~90% due to the nature of the control valve. In detail, seeing the reason, when full open of the control valve is 100%, an interval in which the control valve is able to be stably controlled is an open interval of 10~90%. Herein, an excluded open interval of 0-10% is an interval in which control of the control valve is not smoothly performed due to sheet contact, flow discontinuity, or the like and the remaining excluded open interval of 90~100% is an interval in which sensitivity of control is relatively lowered.

In other words, the reason why an OP (referring to an open degree of the control value) value of the PIC 21 is maintained as 10~15% in an open interval of 10~90% in which the control valve is able to be stably controlled compared to a reference flow rate at an open degree of 100% which is full open may mean that the PIC 21 operates using the lowest value in a controllable operation range or a value included in a certain interval including the lowest value and may operate the PIC 21 in the lowest controllable operation range (e.g., 10~15%) to minimize the amount of start-up gases discharged/emitted to the outside thereof.

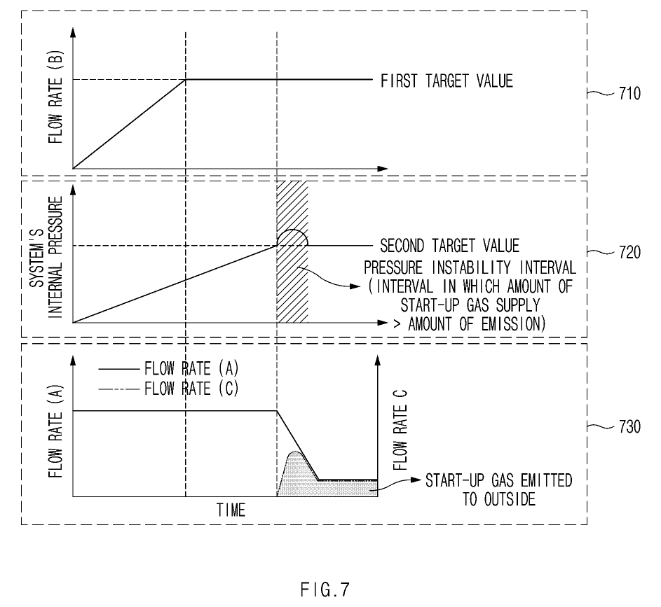

FIG. 7 is a drawing for describing a flow rate and pressure control mechanism via controller interlocking of a steam methane reformer (SMR) and an effect according to it according to an exemplary embodiment of the present disclosure of FIG. 4.

Referring to reference numeral 710 of FIG. 7, when gas A for start-up is supplied, circulation flow rate B may increase and system’s internal pressure may simultaneously increase.

Referring to reference numerals 710 and 720, it may take an additional time t1 until system's internal pressure reaches a predetermined second target value, although circulation flow rate B reaches a predetermined first target value, and internal pressure may be unstable in an interval t2 in which the amount of start-up gas supply is greater than the amount of external emission, although the system’s internal pressure reaches the second target value. At the instant time, to more rapidly enter a normal operation mode, it is important to make an internal pressure instability interval as short as possible.

As shown in reference numeral 730, an SMR 400 according to an exemplary embodiment of the present disclosure may gradually reduce flow rate A of gas for start-up when the internal pressure enters the second target value to minimize consumption of gas for start-up while rapidly stabilizing the system's internal pressure as the second target value. At the instant time, the amount of start-up gas emitted to the outside may be reduced together.

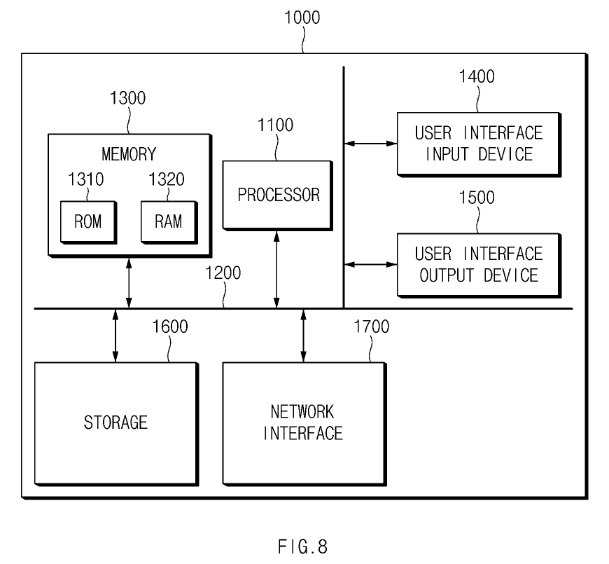

FIG. 8 illustrates a computing system according to an exemplary embodiment of the present disclosure.

Referring to FIG. 8, a computing system 800 may include at least one processor 820, a memory 830, a user interface input device 840, a user interface output device 850, a storage 860, and a network interface 870, which are connected to each other via a bus 810.

The user interface input device 840 and the user interface output device 850 may provide a user interface for an input/output with external diagnostic equipment and/or a system monitoring device.

The network interface 870 may provide a communication means for transmitting and receiving a control signal between internal components of a steam methane reformer 400.

The processor 820 may be a central processing unit (CPU) or a semiconductor device that processes instructions stored in the memory 830 and/or the storage 860. The memory 830 and the storage 860 may include various types of volatile or non-volatile storage media. For example, the memory 830 may include a Read-Only Memory (ROM) 831 and a Random Access Memory (RAM) 832.

Accordingly, the operations of the method (or procedure) or algorithm described in connection with the exemplary embodiments included in the specification may be directly implemented with a hardware module, a software module, or a combination of the hardware module and the software module, which is executed by the processor 820. The software module may reside on a storage medium (i.e., the memory 830 and/or the storage 860) such as a RAM, a flash memory, a ROM, an EPROM, an EEPROM, a register, a hard disc, a removable disk, and a CD-ROM. As an example, the processor 820 may form a part of the above-mentioned steam methane reformer 400 and may particularly correspond to at least one of a flow indicating controller 22 or a pressure indicating controller 21 included in FIG. 4.

The exemplary storage medium may be coupled to the processor 820. The processor 820 may read out information from the storage medium and may write information in the storage medium. Alternatively, the storage medium may be integrated with the processor 820. The processor and the storage medium may reside in an application specific integrated circuit (ASIC). The ASIC may reside in the steam methane reformer 400.

The present technology may provide the method for improving the start-up stability of the steam methane reformer and optimizing the amount of circulating gas used and the apparatus therefor.

Furthermore, the present technology may provide the steam methane reformer configured for adaptively controlling the flow rate of gas for start-up depending on the system's internal pressure to improve the start-up stability and optimize the amount of circulating gas used.

Furthermore, the present technology may provide the method for improving the start-up stability of the steam methane reformer and optimizing the amount of circulating gas used to interlock the pressure indicating controller and the flow indicating controller to adaptively control the mode of the flow indicating controller to minimize the pressure instability interval and minimize the amount of start-up gas emitted to the outside and the apparatus therefor.

Furthermore, various effects ascertained directly or indirectly through the present disclosure may be provided.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

Accordingly, embodiments of the present disclosure are intended not to limit but to explain the technical idea of the present disclosure, and the scope and spirit of the invention is not limited by the above embodiments. The scope of the present disclosure should be construed on the basis of the accompanying claims, and all the technical ideas within the scope equivalent to the claims should be included in the scope of the present disclosure.

What is claimed is:

1. A method of a steam methane reformer, the method comprising:
supplying gas for start-up by opening a supply valve for the gas for start-up, based on start-up of the steam methane reformer;
activating an operation mode of a pressure indicating controller as an auto mode; and
controlling, by the pressure indicating controller, a pressure control valve to match a supply flow rate of the gas for start-up and a flow rate of gas emitted to the outside based on that an internal pressure reaches a target value as the gas for start-up is supplied.

2. The method of claim 1, further comprising:
switching an operation mode of a flow indicating controller from the auto mode to a cascade mode based on that the internal pressure reaches the target value; and
turning on a flow indicating controller set point (SP) calculator for determining an SP of the flow indicating controller based on an output (OP) of the pressure indicating controller.

3. The method of claim 2,
wherein the flow indicating controller for adjusting an open degree of a flow control valve and the pressure indicating controller for adjusting an open degree of the pressure control valve interlock with each other based on the switching to the cascade mode, and
wherein the flow indicating controller SP calculator sets the SP so that the pressure indicating controller stably maintains the internal pressure.

4. The method of claim 3, further comprising:
reducing the supply flow rate of the gas for start-up while maintaining the internal pressure as the target value via the interlocking in the cascade mode.

5. The method of claim 4,
wherein the supply flow rate of the gas for start-up decreases to a set lower limit value of the flow indicating controller, and
wherein the lower limit value is a value at a time point when the open degree of the pressure control valve is 50% in the cascade mode.

6. The method of claim 4, wherein the supply flow rate of the gas for start-up in the cascade mode decreases to a flow rate of a minimum level for stably maintaining the internal pressure.

7. The method of claim 1,
wherein an interval in which the internal pressure is unstable occurs in an interval in which the supply flow rate of the gas for start-up is greater than the flow rate of the gas emitted to the outside after the internal pressure reaches the target value, and
wherein the supply flow rate of the gas for start-up decreases to a level to minimize the unstable interval based on that the internal pressure reaches the target value.

8. The method of claim 1, wherein the target value is set to a value of any one of greater than 0 barg or less than 10 barg.

9. The method of claim 1, wherein the gas for start-up includes at least one or more of hydrogen gas or nitrogen gas.

10. A non-transitory computer readable storage medium on which a program for performing the method of claim 1 is recorded.

11. A steam methane reformer, comprising:
a supply valve for gas for start-up, the supply valve configured to be opened based on start-up and supply the gas for start-up to an inside of the steam methane reformer;
a pressure indicating controller configured to monitor a change in an internal pressure as the gas for start-up is supplied and control the internal pressure; and
a pressure control valve configured to adjust an open degree depending on an output (OP) of the pressure indicating controller and emit the gas for start-up to the outside,
wherein the pressure indicating controller controls the pressure control valve so that a supply flow rate of the gas for start-up and a flow rate of the emitted gas are identical to each other based on that the internal pressure reaches a predetermined target value.

12. The steam methane reformer of claim 11, wherein an operation mode of the pressure indicating controller is activated as an auto mode upon the start-up.

13. The steam methane reformer of claim 12, further comprising:
a flow control valve configured to adjust the supply flow rate of the gas for start-up;
a flow indicating controller configured to control an open degree of the flow control valve; and
a flow indicating controller set point (SP) calculator configured to determine an SP of the flow indicating controller based on the OP of the pressure indicating controller,
wherein an operation mode of the flow indicating controller switches from the auto mode to a cascade mode to turn on the flow indicating controller SP calculator, based on that the internal pressure reaches the target value.

14. The steam methane reformer of claim 13,
wherein the flow indicating controller and the pressure indicating controller interlock with each other based on the switching to the cascade mode, and
wherein the flow indicating controller SP calculator sets the SP so that the pressure indicating controller stably maintains the internal pressure.

15. The steam methane reformer of claim 14, wherein the pressure indicating controller controls the flow indicating controller to decrease the supply flow rate of the gas for start-up while maintaining the internal pressure as the target value via the interlocking in the cascade mode.

16. The steam methane reformer of claim 15,
wherein the supply flow rate of the gas for start-up decreases to a set lower limit value of the flow indicating controller, and
wherein the lower limit value is a value at a time point when the open degree of the pressure control valve is 50% in the cascade mode.

17. The steam methane reformer of claim 15, wherein the supply flow rate of the gas for start-up in the cascade mode decreases to a flow rate of a minimum level for stably maintaining the internal pressure.

18. The steam methane reformer of claim 11,
wherein an interval in which the internal pressure is unstable occurs in an interval in which the supply flow rate of the gas for start-up is greater than the flow rate of the gas emitted to the outside after the internal pressure reaches the target value, and
wherein the supply flow rate of the gas for start-up decreases to a level to minimize the unstable interval based on that the internal pressure reaches the target value.

19. The steam methane reformer of claim 11, wherein the target value is set to a value of any one of greater than 0 barg or less than 10 barg.

20. The steam methane reformer of claim 11, wherein the gas for start-up includes at least one or more of hydrogen gas or nitrogen gas.
